(19) United States
(12) Patent Application Publication
(10) Pub. No.: US 2022/0078381 A1
(43) Pub. Date: Mar. 10, 2022

(54) SPATIAL LIGHT MODULATION MODULE, SPATIAL LIGHT MODULATION ELEMENT, LIGHT SHIELDING PLATE, AND PROJECTION TYPE DISPLAY DEVICE

(71) Applicant: SONY GROUP CORPORATION, TOKYO (JP)

(72) Inventors: GEN YONEZAWA, TOKYO (JP); MOTOSUKE OHMI, KANAGAWA (JP)

(21) Appl. No.: 17/309,947

(22) PCT Filed: Dec. 7, 2019
(86) PCT No.: PCT/JP2019/047975

§ 371 Date: Jul. 2, 2021

(30) Foreign Application Priority Data
Jan. 17, 2019 (JP) 2019-005718

(51) Int. Cl. H04N 9/31; G03B 21/14; G02F 1/1335; G02F 1/13363

(52) U.S. Cl. CPC H04N 9/3102; G03B 21/142; G02F 1/133553; G02F 1/13363; G02F 1/133512

(57) ABSTRACT

An object of the present technology is to provide a technology for processing light that reaches a light shielding plate that defines a reachable range of light to a panel unit. The present technology provides a spatial light modulation module including: a panel unit that forms image display light; and a light shielding plate that defines an illumination light reachable range of the panel unit, in which at least a part of an illumination light reachable surface of the light shielding plate is inclined with respect to a reflection surface of the panel unit. It is preferable that at least a part of the illumination light reachable surface reflects the illumination light. Furthermore, the present technology also provides a spatial light modulation element and a light shielding plate included in the module. Furthermore, the present technology also provides a projection type display device including the module.

### TECHNICAL FIELD

The present technology relates to a spatial light modulation module, a spatial light modulation element, a light shielding plate, and a projection type display device. More specifically, the present technology relates to: a spatial light modulation module capable of preventing a temperature rise due to illumination light reaching a light shielding plate that defines an illumination light reachable range of a panel unit; a spatial light modulation element and a light shielding plate included in the spatial light modulation module; and a projection type display device including the spatial light modulation module.

### BACKGROUND ART

In order to realize high brightness of a projector, an output of a light source may be increased. As the output of the light source increases, an amount of light incident on an illumination system, a panel core unit, and a projection lens of the projector increases. However, an increase in the amount of light may cause an increase in temperature of an optical component and a holding member of the optical component, and may also cause deformation or deterioration thereof. Therefore, some technologies for coping with the temperature rise have been proposed so far.

For example, Patent Document 1 below discloses an electro-optical apparatus in a mounting case. The apparatus includes a specific dustproof substrate, two specific light shielding films, and a specific mounting case, and the two light shielding films, the dustproof substrate, and the mounting case form a heat conduction path. Patent Document 1 below discloses that the dustproof substrate functions as a heat sink for the electro-optical apparatus, and the two light shielding films and the mounting case prevent excessive incident of light source light on the electro-optical apparatus to suppress the conversion action of light into heat in the electro-optical apparatus. Furthermore, Patent Document 1 below discloses that the two light shielding films, the dustproof substrate, and the mounting case form a heat conduction path, so that the heat inside the electro-optical apparatus is transferred to the outside by the heat conduction path.

A projector disclosed in Patent Document 2 below has a polarization separating element between an optical modulator and a polarizing element, and the polarization separating element separates colored light emitted from the optical modulator into two types of linearly polarized light fluxes having different polarization directions, emits one of the two types of linearly polarized light fluxes to a color synthesis optical apparatus, and emits another one of the linearly polarized light fluxes in another direction. The projector further includes a solar cell that receives and converts the another one of the linearly polarized light fluxes into electrical energy.

### CITATION LIST

### Patent Document

Patent Document 1: Japanese Patent Application Laid-Open No. 2004-062197

Patent Document 2: Japanese Patent Application Laid-Open No. 2009-122413

### SUMMARY OF THE INVENTION

### Problems to be Solved by the Invention

For example, in order to uniformly irradiate a spatial light modulation module panel unit such as a reflective spatial light modulation element with light, in general, a spatial light modulation module may be designed so that a light irradiation range is slightly larger than an effective range of the panel unit. One reason for designing as described above is that there is a case where, in a peripheral portion of the light irradiation range, illuminance may become uneven or brightness uniformity may degrade due to, for example, lens aberration that occurs when light passes through a plurality of lens systems in an illumination system, component tolerance when a plurality of components is assembled, or the like. Furthermore, another reason for designing as described above is that there is a case where, after a projector including the spatial light modulation module is assembled, the illumination range is displaced due to the displacement of the components due to a load such as heat or vibration, for example, and as a result, the irradiation range of a screen may be chipped.

In the spatial light modulation module designed as described above, in order to allow light to reach only the effective range of the panel unit, a light shielding plate for defining the reach range of light may be arranged in the vicinity of the panel unit. The light shielding plate is generally subjected to black coating to absorb light that reaches outside the effective range.

When an amount of light incident on the panel unit is increased in order to achieve high brightness of the projector, an amount of light absorbed by the light shielding plate also increases. The increase in the amount of light absorbed may cause an increase in the temperature of the light shielding plate. Moreover, the radiant heat from the light shielding plate causes temperature unevenness in the panel unit, and further causes black unevenness (abnormal image quality). In order to reduce the temperature of the light shielding plate, it is conceivable to provide a cooling structure around the light shielding plate, but such a cooling structure is not desirable from the viewpoint of miniaturization of the apparatus.

Therefore, the main purpose of the present technology is to provide a technology for processing light that reaches a light shielding plate that defines an illumination light reachable range of a panel unit.

### Solutions to Problems

The present technology provides a spatial light modulation module including: a panel unit that forms image display light; and a light shielding plate that defines an illumination light reachable range of the panel unit, in which at least a part of an illumination light reachable surface of the light shielding plate is inclined with respect to a reflection surface of the panel unit.

The at least a part of the illumination light reachable surface may reflect illumination light.

According to one embodiment of the present technology, the panel unit may be a reflective liquid crystal panel.

The spatial light modulation module may be configured so that illumination light reflected by the illumination light reachable surface is not captured by a projection lens through which the image display light passes.

An angle θ formed by the at least a part of the illumination light reachable surface and the reflection surface of the panel unit satisfies the Equation (1) below.

θ>sin⁻¹ (1/2F#) (1)

In Equation (1), F# can be an F value on the panel unit side of the projection lens through which the image display light passes.

In the light shielding plate, an edge region that defines a window that defines the illumination light reachable range of the panel unit may be inclined with respect to the reflection surface of the panel unit.

The edge region may be inclined with respect to the reflection surface of the panel unit over the entire circumference of the window.

A retardation plate may be stacked on the light shielding plate.

The phase of the illumination light can be adjusted so that the retardation plate imparts, to the illumination light reflected by the light shielding plate, a phase difference equal to the phase difference imparted to the image display light by a pre-tilt of the panel unit.

The light shielding plate may be connected to a heat receiving medium that receives heat of the light shielding plate.

The light shielding plate and/or the heat receiving medium may be formed including a metal material.

The light shielding plate may be a photoelectric conversion element.

The spatial light modulation module may further include a damper that prevents the illumination light reflected by the light shielding plate from reaching a projection lens or a projection lens housing.

An end portion of the edge region that defines the window that defines the illumination light reachable range of the panel unit may be configured so as not to reflect the illumination light.

A surface opposite to the illumination light reachable surface of the light shielding plate may absorb light.

According to another embodiment of the present technology, the panel unit may include a DMD array.

Furthermore, the present technology also provides a spatial light modulation module including: a panel unit that forms image display light; and a light shielding plate that defines an illumination light reachable range of the panel unit, in which a retardation plate is stacked on the light shielding plate.

Furthermore, the present technology also provides a spatial light modulation element used in combination with a light shielding plate that defines an illumination light reachable range of a panel unit that forms image display light in the spatial light modulation element, at least a part of the illumination light reachable surface of the light shielding plate being inclined to a reflection surface of the panel unit.

Furthermore, the present technology also provides a light shielding plate used for defining an illumination light reachable range of a panel unit that forms image display light in the spatial light modulation element, at least a part of the illumination light reachable surface being inclined to a reflection surface of the panel unit.

Furthermore, the present technology also provides a projection type display device including a spatial light modulation module including: a panel unit that forms image display light; and a light shielding plate that defines an illumination light reachable range of the panel unit, in which at least a part of an illumination light reachable surface of the light shielding plate is inclined with respect to a reflection surface of the panel unit.

### BRIEF DESCRIPTION OF DRAWINGS

FIG. 1 is a simple schematic diagram illustrating an example of a configuration of a panel unit and a light shielding plate in a conventional spatial light modulation module.

FIG. 2 is a simple schematic diagram for explaining an example of a configuration of a panel unit and a light shielding plate in a spatial light modulation module according to the present technology.

FIG. 3A is a schematic cross-sectional view of a spatial light modulation module according to the present technology.

FIG. 3B is a diagram for explaining an angle formed by an illumination light reachable surface (inclined surface) of the light shielding plate and a panel unit plane.

FIG. 4 is a diagram illustrating an example of components included in the spatial light modulation module according to the present technology.

FIG. 5 is a diagram illustrating an example of the spatial light modulation module according to the present technology including a damper.

FIG. 6 is a diagram for explaining a spatial light modulation module including a DMD array.

FIG. 7 is a simple schematic view of an example of a spatial light modulation module including a light shielding plate whose illumination light reachable surface is parallel to a panel surface and can reflect illumination light.

FIG. 8 is a simple schematic diagram of an example of the spatial light modulation module according to the present technology.

FIG. 9 is a schematic cross-sectional view of a spatial light modulation module according to the present technology.

FIG. 10 is a schematic diagram of a configuration example of a projection type display device according to the present technology.

FIG. 11 is a schematic diagram of a configuration example of a projection type display device according to the present technology.

FIG. 12 is a diagram for explaining black level degradation around an effective screen range.

FIG. 13 is a diagram illustrating an example of a combination of one PBS and one spatial light modulation module included in the projection type display device according to the present technology.

FIG. 14 is a diagram illustrating an example of a combination of one PBS and two spatial light modulation modules included in the projection type display device according to the present technology.

### MODE FOR CARRYING OUT THE INVENTION

Hereinafter, preferred embodiments for carrying out the present technology will be described. Note that the embodiments described below are typical embodiments of the present technology, and the scope of the present technology should not be limited to these embodiments. Note that the present technology will be described in the following order.

1. First embodiment (spatial light modulation module)

(1) Description of first embodiment

(2) Example of first embodiment (example of spatial light modulation module)
(2-1) Example of configuration of spatial light modulation module
(2-2) Modification (light shielding plate on which retardation plate is stacked)
(2-3) Modification (light shielding plate to which heat receiving medium is connected)
(2-4) Modification (light shielding plate configured as photoelectric conversion element)
(2-5) Modification (example including damper)
(2-6) Modification (processing of end portion of light shielding plate)
(2-7) Modification (light absorption by panel side surface of light shielding plate)
(2-8) Modification (spatial light modulation module including DMD array)

2. Second embodiment (spatial light modulation module)

(1) Description of second embodiment

(2) Example of second embodiment (example of spatial light modulation module)

3. Third embodiment (spatial light modulation element)

4. Fourth embodiment (light shielding plate)

5. Fifth embodiment (projection type display device)

(1) First example of fifth embodiment (projection type display device including reflective liquid crystal display element)

(2) Second example of fifth embodiment (projection type display device including DMD array)

6. Example

### 1. First Embodiment (Spatial Light Modulation Module)

(1) Description of First Embodiment

A spatial light modulation module according to the present technology includes: a panel unit that forms image display light; and a light shielding plate that defines an illumination light reachable range of the panel unit, and at least a part of an illumination light reachable surface of the light shielding plate is inclined with respect to a reflection surface of the panel unit. In the present specification, a part of the illumination light reachable surface that is inclined as described above is also referred to as an “inclined surface”. That is, the illumination light reachable surface includes an inclined surface. Since the illumination light reachable surface includes an inclined surface, it is possible to prevent the illumination light (unnecessary light) reflected by the light shielding plate from entering the projection lens through which the image display light passes, and thereby, it is also possible to form the illumination light reachable surface as a reflection surface. By making the illumination light reachable surface a reflection surface, it is possible to suppress the temperature rise of the light shielding plate.

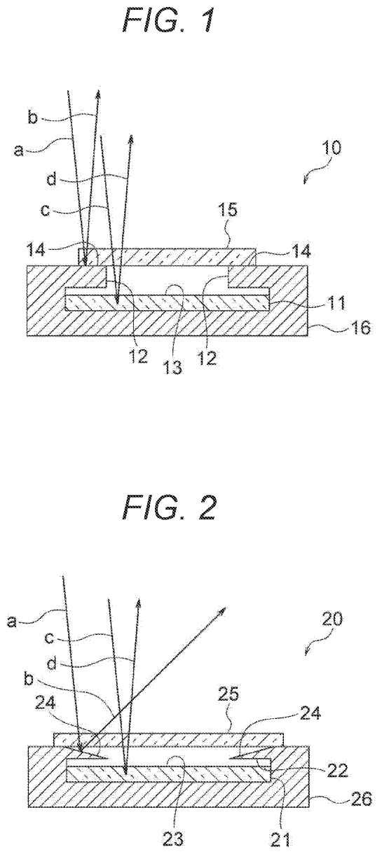

The basic concept of the spatial light modulation module according to the present technology will be described below with reference to FIGS. 1 and 2. FIG. 1 is a simple schematic diagram illustrating an example of a configuration of a panel unit and a light shielding plate in a conventional spatial light modulation module. FIG. 2 is a simple schematic diagram for explaining an example of a configuration of a panel unit and a light shielding plate in a spatial light modulation module according to the present technology.

A spatial light modulation module 10 illustrated in FIG. 1 includes a panel unit 11 that forms image display light, and a light shielding plate 12 that defines an illumination light reachable range of the panel unit. The spatial light modulation module 10 further includes a retarder 15. The range in which the illumination light reaches the reflection surface 13 of the panel unit 11 is defined by the light shielding plate 12. For example, of the illumination light that has passed through the retarder 15, the illumination light indicated by the arrow a reaches the light shielding plate 12 and does not reach the panel unit 11. In a case where the light shielding plate 12 has a light absorbing property, the light that reaches the light shielding plate 12 may be absorbed by a surface on which the illumination light reaches (also referred to as “illumination light reachable surface” in the present specification) 14, and in a case where the light shielding plate 15 has a light reflecting property, the light may be reflected as reflected light indicated by the arrow b on the illumination light reachable surface 14. On the other hand, of the illumination light that has passed through the retarder 15, the illumination light indicated by the arrow c reaches the panel unit 11 without being blocked by the light shielding plate 15. The illumination light indicated by the arrow c is modulated by the panel unit 11 and exits from the panel unit 11 as image display light d. The illumination light reachable surface 14 is generally subjected to black coating to absorb the light that has reached the illumination light reachable surface 14, and this is for preventing the light reflected by the surface from causing black level degradation around the image. Furthermore, since the light that has reached the illumination light reachable surface 14 is absorbed by the black coating, it is not necessary to consider the reflection of the illumination light on the illumination light reachable surface 14, and the illumination light reachable surface 14 is parallel to the reflection surface 13 of the panel unit 11. However, as described above, as the brightness of the projector increases, there may be a problem that the temperature of the light shielding plate 12 rises due to the illumination light. Furthermore, in a case where the illumination light reachable surface 14 is formed so as to have a reflecting property in order to prevent the temperature rise, black level degradation may occur around the screen range. Therefore, a new technology for processing the illumination light that reaches the light shielding plate 12 is required.

A spatial light modulation module 20 illustrated in FIG. 2 includes: a panel unit 21 that forms image display light; and a light shielding plate 22 that defines an illumination light reachable range of the panel unit, and an illumination light reachable surface 24 of the light shielding plate 22 is inclined with respect to a reflection surface 23 of the panel unit 21. The spatial light modulation module 20 further includes a retarder 25. Due to the inclination, the amount of light that travels to the projection lens among the light reflected by the illumination light reachable surface 24 can be reduced, and moreover, depending on the inclination angle, the light reflected by the illumination light reachable surface 24 is not captured by the projection lens. Therefore, it is possible to prevent black level degradation around the screen. Moreover, since the light reflected by the illumination light reachable surface 24 is not captured by the projection lens, it is not necessary to subject the illumination light reachable surface 24 to black coating, and the illumination light reachable surface 24 may be configured to reflect the light. As a result, it is possible to suppress the temperature rise of the light shielding plate due to light absorption, and moreover, it is possible to suppress the temperature rise of the panel unit due to the radiant heat accompanying the temperature rise.

Since the spatial light modulation module according to the present technology suppresses the temperature rise of the light shielding plate as described above, the spatial light modulation module solves the problem caused by the temperature rise even in a case where a light source of high brightness is used.

Furthermore, as described above, the spatial light modulation module according to the present technology can suppress the temperature rise of the panel unit due to radiant heat. Therefore, the components for cooling the panel unit (for example, a heat sink or the like) can be miniaturized, and this also contributes to the miniaturization of the projection type display device itself. Furthermore, the life of the spatial light modulation element can be extended by suppressing the temperature rise of the panel unit.

(2) Example of First Embodiment (Example of Spatial Light Modulation Module)

(2-1) Example of Configuration of Spatial Light Modulation Module

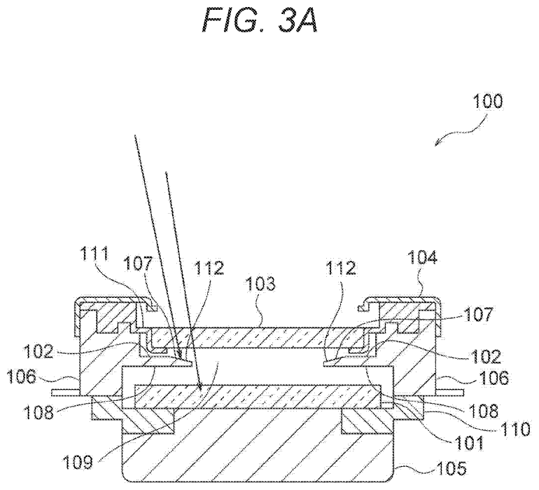

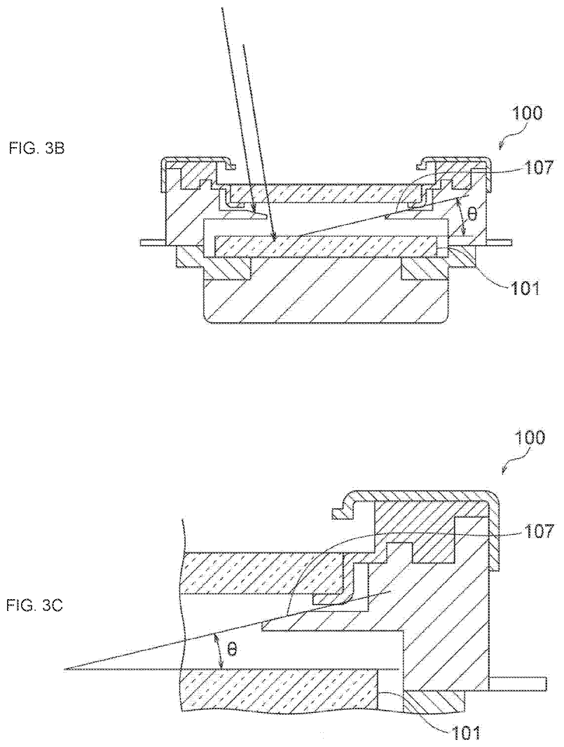

An example of the spatial light modulation module according to the present technology will be described below with reference to FIG. 3A. FIG. 3A is a schematic cross-sectional view of the spatial light modulation module according to the present technology.

The spatial light modulation module 100 illustrated in FIG. 3A includes a panel unit 101, a light shielding plate 102, a retarder 103, and a pre-light shielding plate 104. The spatial light modulation module 100 further includes a heat sink 105.

The panel unit 101 is a unit of the spatial light modulation element in which image display light is formed from illumination light. That is, the panel unit 101 modulates the incident illumination light to form the image display light. The panel unit 101 is a panel unit (reflective liquid crystal panel) of the reflective liquid crystal display element, and the incident illumination light is modulated and reflected. An LCOS panel may be used as the panel unit 101. As the reflective liquid crystal panel, those known in the art may be used. The panel unit 101 is mounted on a panel holder 110.

The light shielding plate 102 defines the illumination light reachable range of the panel unit 101. In FIG. 3A, the light shielding plate 102 is integrated with a panel cover 106 that covers the panel unit 101, but the light shielding plate 102 does not have to be integrated. The light shielding plate 102 has an illumination light reachable surface 107 and a panel-side surface 108 on the opposite side of the illumination light reachable surface 107.

The light shielding plate 102 is provided with a window 109 for defining the illumination light reachable range. The illumination light that has passed through the window 109 reaches the panel unit 101, and the panel unit 101 forms image display light from the illumination light. The shape of the window 109 may be appropriately set according to the shape of the desired video region or the shape of the effective range of the panel unit 101, but is generally rectangular in a case of being viewed from the incident side of the illumination light (in a case where the panel unit 101 is viewed from the upper side of the drawing of FIG. 3A).

As illustrated in FIG. 3A, the illumination light reachable surface 107 of the light shielding plate 102 is inclined with respect to the reflection surface of the panel unit 101. That is, the illumination light reachable surface 107 has an inclined surface 112. Since the illumination light reachable surface 107 has the inclined surface 112, it is possible to reduce an amount of illumination light reflected by the light shielding plate 102 that is incident on, for example, a projection lens or the like.

According to a particularly preferred embodiment of the present technology, the at least a part (that is, the inclined surface) of the illumination light reachable surface may reflect the illumination light. For example, the entire illumination light reachable surface 107 or the entire inclined surface 112 in FIG. 3A may reflect the illumination light. The inclined surface may be mirror-finished, for example, in order to reflect the illumination light. By reflecting the illumination light, it is possible to prevent the temperature rise of the illumination light reachable surface due to the illumination light, and this also solves the problem of radiant heat described above.

According to a particularly preferred embodiment of the present technology, the spatial light modulation module may be configured so that illumination light reflected by the illumination light reachable surface (particularly, the inclined surface) is not captured by a projection lens through which the image display light passes. Therefore, for example, the reflected light around the effective pixels of the panel unit 101 does not enter the projection lens and does not adversely affect the image quality of the projection type display device including the spatial light modulation module 100.

In this embodiment, the spatial light modulation module can be used in combination with a projection lens. The combination of the spatial light modulation module and the projection lens may be adopted, for example, in a projection type display device. The projection type display device may include a plurality of projection lenses through which the image display light passes. In a case where the projection type display device includes a plurality of projection lenses, configuration may be made so that the projection lens through which light first passes after exiting the spatial light modulation module does not capture the illumination light reflected by the illumination light reachable surface.

Particularly preferably, an angle θ formed by the at least a part of the illumination light reachable surface (that is, the inclined surface) and the reflection surface of the panel unit satisfies Equation (1) below.

θ>sin⁻¹ (1/2F#) (1)

In Equation (1) described above, F# is an F value on the panel unit side of the projection lens through which the image display light passes.

The angle θ is an angle illustrated in (a) and (b) of FIG. 3B. In (a) of FIG. 3B, θ is added to FIG. 3A, and in (b) of FIG. 3B, the portion of (a) indicating θ is enlarged.

By configuring the at least a part of the illumination light reachable surface and the reflection surface of the panel unit so as to satisfy Equation (1) described above, it is possible to more reliably prevent the illumination light reflected by the at least a part of the illumination light reachable surface from being captured by the projection lens.

Of the illumination light reachable surface 107 of the light shielding plate 102, the edge region that defines the window 109 is preferably inclined with respect to the reflection surface of the panel unit 101. Moreover, the edge region is more preferably inclined with respect to the reflection surface of the panel unit over the entire circumference of the window 109. As described above, the spatial light modulation module is generally designed so that the irradiation range to the panel unit is slightly larger than the effective range of the panel unit, and the illumination range is generally set to be larger than the entire circumference of the panel unit. Therefore, as described above, it is preferable that the edge region is inclined over the entire circumference of the window 109.

As illustrated in FIG. 3A, the retarder 103 is arranged so that the retarder 103, the light shielding plate 102, and the panel unit 101 are arranged in this order. That is, the illumination light modulated into the image display light passes through the retarder 103, then passes through the window 109 of the light shielding plate 102, and reaches the panel unit 101. The retarder 103 is made of a birefringent material and causes a phase difference between a fast axis and a slow axis. The optical axis of the retarder 103 is set parallel to the surface, and the polarization state of the light is continuously changed by rotating the polarizing surface with respect to the light incident perpendicularly to the surface of the retarder 103. The retarder 103 may be a liquid crystal retarder that electrically changes the polarization state of light by utilizing the birefringence of a substance having optical anisotropy. The retarder 103 is mounted on a retarder holder 111.

The pre-light shielding plate 104 adjusts the shape of the illumination light incident on the retarder 103. That is, the shape of the illumination light incident on the retarder 103 is defined by the window of the pre-light shielding plate 104. The shape of the window of the pre-light shielding plate 104 may be appropriately set according to the shape of the retarder 103.

The heat sink 105 is a heat radiating member that dissipates heat generated in the panel unit 101. The heat sink 105 is provided on the panel unit 101 on the side opposite to the side on which the illumination light is incident. The material of the heat sink 105 may be any material suitable for heat dissipation, and may be, for example, a resin material such as plastic having high thermal conductivity or a metal material such as aluminum, for example.

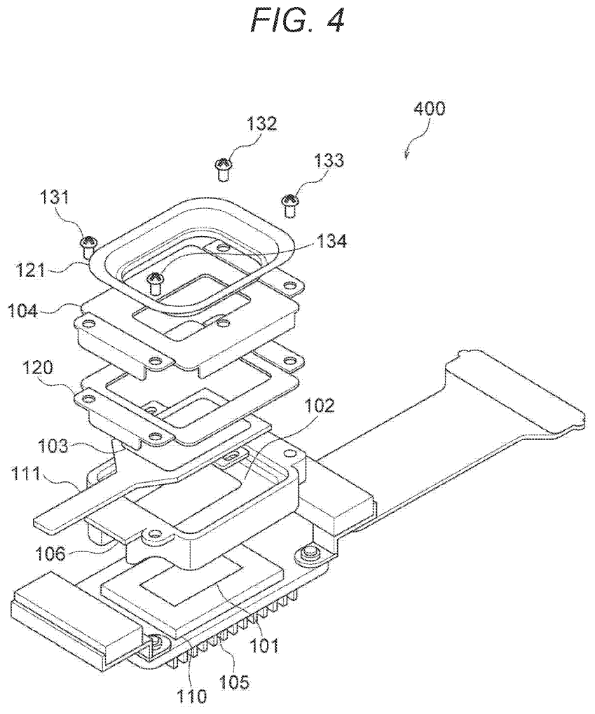

A configuration example of the spatial light modulation module according to the present technology will be described below with reference to FIG. 4. FIG. 4 is a diagram illustrating an example of components included in the spatial light modulation module according to the present technology.

As illustrated in FIG. 4, the spatial light modulation module 400 according to the present technology includes the heat sink 105, the panel holder 110, the panel unit 101, the panel cover 106, the retarder holder 111, the retarder 103, a dustproof sheet 120, and the pre-light shielding plate 104, the light shielding plate 102 is integrated with the panel cover 106, and the edge region of the light shielding plate 102 that defines the window 109 is inclined, that is, the spatial light modulation module 400 has an inclined surface (in FIG. 4, the depiction of the inclination is omitted).

The heat sink 105, the panel holder 110, the panel unit 101, the panel cover 106, the retarder holder 111, the retarder 103, the dustproof sheet 120, and the pre-light shielding plate 104 may be fixed by four screws 131 to 134. The spatial light modulation module 400 may include dustproof rubber 121.

(2-2) Modification (Light Shielding Plate on Which Retardation Plate is Stacked) s

[symbol]

It is preferable that the phase of the illumination light can be adjusted so that the retardation plate imparts, to the illumination light reflected by the light shielding plate 102, a phase difference equal to the phase difference imparted to the image display light by a pre-tilt of the panel unit 101. By adjusting the phase difference of the light reflected by the light shielding plate 102 as described above, the optical path length of the image display light formed by the panel unit 101 and the optical path length of the illumination light reflected by the light shielding plate 102 become the same, and it is possible to make the contrast of these two pieces of light the same. Therefore, it is possible to reduce the influence of the light reflected by the light shielding plate 102 on the image.

(2-3) Modification (Light Shielding Plate to Which Heat Receiving Medium is Connected)

According to one embodiment of the present technology, the light shielding plate may be connected to a heat receiving medium that receives heat of the light shielding plate. Therefore, the temperature rise of the light shielding plate can be prevented, so that the influence of radiant heat on the panel unit can be reduced. In this embodiment, it is preferable that the light shielding plate and/or the heat receiving medium may be formed including, for example, a metal material such as aluminum.

The heat receiving medium may be the panel cover 106 illustrated in FIG. 3. That is, the light shielding plate 102 may be integrated with the panel cover 106 as the heat receiving medium. In this case, for example, the light shielding plate 102 and the panel cover 106 are both formed including a resin material such as plastic having high thermal conductivity or a metal material having high thermal conductivity (for example, aluminum, an aluminum alloy, or the like), and in the light shielding plate 102, the illumination light reachable surface 107 or the inclined surface 112 may be mirror-finished.

Alternatively, the heat receiving multimedia may be provided as another component separate from the panel cover. The another component may include, for example, a resin material such as a plastic having high thermal conductivity or a metal material having high thermal conductivity (for example, aluminum, an aluminum alloy, or the like). For example, the heat receiving multimedia may be in contact with the light shielding plate 102 so that the heat receiving multimedia can receive the heat of the light shielding plate 102.

(2-4) Modification (Light Shielding Plate Configured as Photoelectric Conversion Element)

According to one embodiment of the present technology, the light shielding plate can be a photoelectric conversion element. For example, a part of the light shielding plate 102 illustrated in FIG. 3 may be configured as a photoelectric conversion element, or the entire light shielding plate 102 may be configured as a photoelectric conversion element. It is preferable that the photoelectric conversion element may be provided on the illumination light reachable surface 107. Since the light shielding plate is configured as a photoelectric conversion element, electric power can be obtained from the illumination light that reaches the light shielding plate. The electric power can be used, for example, as energy for cooling the spatial light modulation module and its peripheral components. As described above, since the output of the light source is increased to increase the brightness, the power obtained from the photoelectric conversion element is also large.

(2-5) Modification (Example Including Damper)

The spatial light modulation module according to the present technology may further include a damper that prevents the illumination light reflected by the light shielding plate from reaching a projection lens or a projection lens housing. The damper can prevent the temperature of the projection lens or the projection lens housing from rising due to the illumination light reflected by the light shielding plate. For example, when the temperature of the projection lens rises, the focus performance of the projection lens deteriorates due to the thermal lens effect. Therefore, the focus performance can be maintained by preventing the temperature rise as described above.

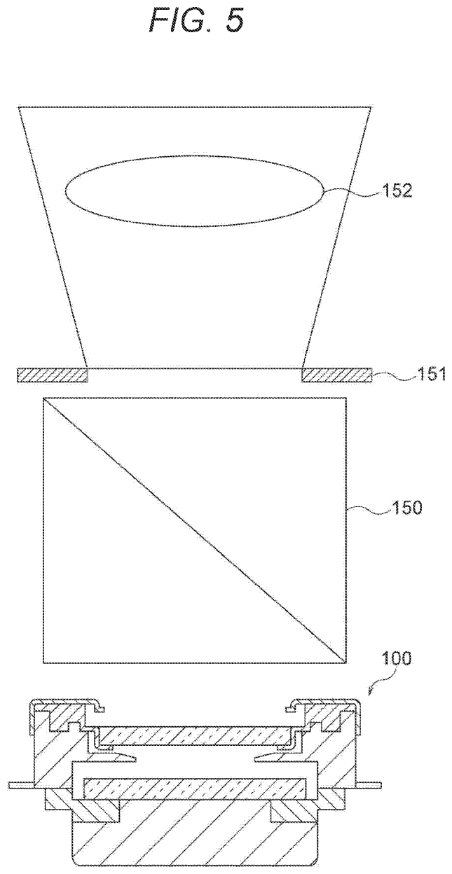

FIG. 5 illustrates an example of the spatial light modulation module according to the present technology including a damper. FIG. 5 is the same as FIG. 3 except that a polarizing beam splitter (hereinafter, referred to as PBS) 150, a damper 151, and a projection lens 152 are added. Therefore, the description regarding FIG. 3 applies to other components.

In the configuration example illustrated in FIG. 5, the illumination light travels to the spatial light modulation module 100 via the PBS 150, and in the panel unit 101 of the spatial light modulation module 100, an image display light is formed from the illumination light. The image display light travels toward the PBS 150, passes through the PBS, and enters the projection lens 152. The damper 151 is arranged between the PBS 150 and the projection lens 152.

Part of the illumination light is reflected by the light shielding plate 102. When the reflected illumination light reaches the projection lens 152 or the projection lens housing (not shown) including the projection lens 152, the temperature of the projection lens 152 may rise. The damper 151 can prevent the illumination light from reaching the projection lens 152 or the projection lens housing, and can prevent the temperature of the projection lens 152 from rising.

(2-6) Modification (Processing of End Portion of Light Shielding Plate)

According to a preferred embodiment of the present technology, the end portion (which can be said to be a boundary region between the window and the inclined surface) of the edge region that defines the window defining the illumination light reachable range of the panel unit is configured so as not to reflect the illumination light. For example, the end portion may be subjected to black coating so as to be configured not to reflect the illumination light.

A bright line may occur in an image due to the end portion reflecting the illumination light. The bright line may occur due to, for example, an edge standing at the end portion (generation of a convex portion at the end portion) or generation of a sagging at the end portion during polishing for mirror finishing (the end portion becoming rounded). As described above, by configuring the end portion so as not to reflect the illumination light, it is possible to prevent the bright line from being generated.

(2-7) Modification (Light Absorption by Panel-Side Surface of Light Shielding Plate)

According to a preferred embodiment of the present technology, a surface opposite to the illumination light reachable surface of the light shielding plate may absorb light. For example, in FIG. 3A, the surface 108 on the panel unit side may be configured as a surface that absorbs light, and may be subjected to black coating, for example. The black coating may be, for example, a matte black alumite processing. In a case where the side surface 108 of the panel unit has a light reflecting property, the internally propagated light (for example, leaked light) may cause black level degradation on the screen formed by the liquid crystal element. By configuring the surface 108 on the panel unit side as a surface that absorbs light, the black level degradation can be prevented. Note that the amount of light absorbed by the panel unit side surface 108 is extremely small as compared with the amount of light reaching the illumination light reachable surface 107, and the effect of heat generation due to the light absorption by the panel unit side surface 108 is extremely small.

(2-8) Modification (Spatial Light Modulation Module Including DMD Array)

In the present technology, as the spatial light modulation element, a spatial light modulation element including a digital micromirror device (DMD) array may be used. That is, a spatial light modulation module of the present technology may include: a panel unit including a DMD array; and a light shielding plate that defines an illumination light reachable range of the panel unit, and at least a part of an illumination light reachable surface of the light shielding plate may be inclined with respect to a reflection surface of the panel unit. Even in a case where a DMD array is used instead of an LCOS, the effects described above can be achieved.

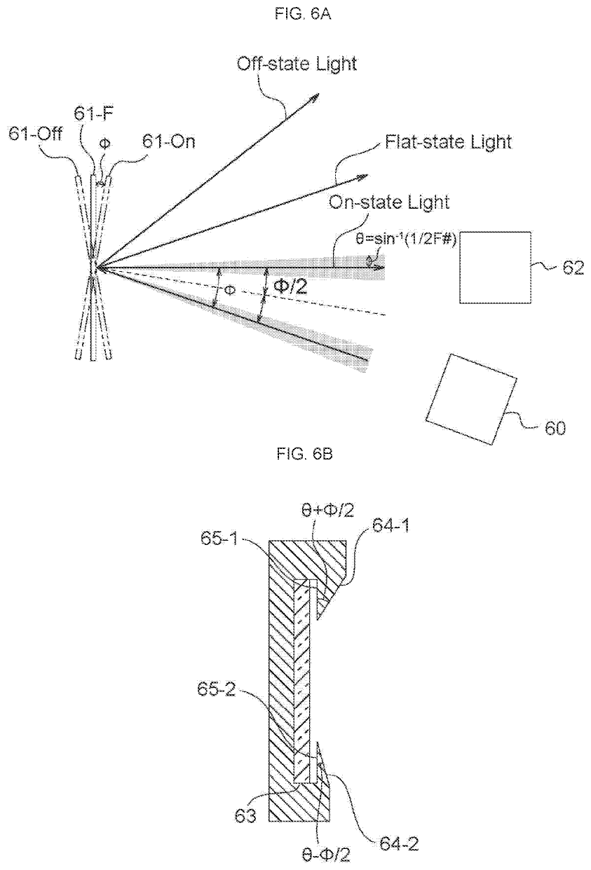

The DMD array has a configuration in which a large number of movable micromirrors (for example, aluminum alloy mirrors or the like) are arrayed on an integrated circuit. The video display light is formed by setting the inclination of each micromirror to the On state of reflecting the light toward the projection lens or the Off state of reflecting the light to other than the projection lens. For example, as illustrated in FIG. 6(a), the illumination light from the light source 60 reaches the micromirror 61. In a case where the micromirror 61 is in the On state (61-On), the light reflected by the micromirror 61 travels to the projection lens 62. On the other hand, in a case where the micromirror 61 is in the Off state (61-Off), the light reflected by the micromirror 61 travels to other than the projection lens 62 and does not form the image display light.

In this modification, the reflection surface of the panel unit refers to the surface of the micromirror in the FLAT state (61-F), for example, as illustrated in FIG. 6(a). At least a part (inclined surface) of the illumination light reachable surface of the light shielding plate may be inclined with respect to the surface in the FLAT state. The angle between the surface in the FLAT state and the inclined surface may be preferably set on the basis of the F value on the panel unit side of the projection lens through which the image display light passes (for example, set so as to satisfy Equation (1) described above), and more preferably, may be set on the basis of the F value and the tilt angle of the micromirror 61 (particularly, the tilt angle in the On state). For example, the angle may be θ′ satisfying Equation (2) below.

θ′=sin⁻¹ (1/2F#)±Φ/2 (2)

Equation (2) described above will be described with reference to (a) and (b) of FIG. 6. In Equation (2), F# is an F value on the panel unit side of the projection lens through which the image display light passes, as similar to that in Equation (1) described above. Φ is a tilt angle of the micromirror 61, that is, an angle formed from the surface of the micromirror 61 in the FLAT state described above and the surface of the micromirror 61 in the ON state. Considering the tilt angle, it is preferable that the angle obtained by adding Φ/2 to sin⁻¹ (1/2F #) or subtracting Φ/2 is formed by the inclined surface and the surface of the panel unit (micro mirror surface in the FLAT state).

An example of a light shielding plate having an angle satisfying Equation (2) described above is illustrated in FIG. 6(b). In FIG. 6(b), the light shielding plates 65-1 and 65-2 define the illumination light reachable range of the panel unit 63 including the DMD array. The panel unit 63 and the light shielding plate 65 are arranged so that the illumination light reachable surface 64-1 (light shielding plate 65-1) is located on the traveling direction side of the reflected light in the Off state illustrated in (a) of FIG. 6, and the illumination light reachable surface 64-2 (light shielding plate 65-2) is located on the traveling direction side of the illumination light illustrated in (a) of FIG. 6. The angle θ₁′ formed from the illumination light reachable surface 64-1 of the light shielding plate 65-1 and the surface of the micromirror in the FLAT state of the panel unit 63 is represented by θ+Φ/2, where θ=sin⁻¹ (1/2F#). Furthermore, the angle θ₂′ formed from the illumination light reachable surface 64-2 of the light shielding plate 65-2 and the surface of the micromirror in the FLAT state of the panel unit 63 forms an angle of θ-Φ/2. Note that the angles θ₁′ and θ₂′ are angles formed by each inclined surface and the surface of the micromirror in the FLAT state, but in (b) of FIG. 6, the angles 01′ and 02′ are illustrated as angles formed by each inclined surface and lower surfaces of the light shielding plates 65-1 and 65-2, assuming that the surface of the micromirror and the lower surfaces are parallel to each other. As described above, the inclination angles of the two inclined surfaces facing each other may be different from each other on the basis of the tilt angle of the micromirror.

In a case where the panel unit includes a DMD array, the illumination light to the panel unit is obliquely incident on the panel surface, and switching between the On state and the Off state is controlled by the tilt angle of the micromirror. Therefore, as described above, by forming the angle of the inclined surface in consideration of the F value and the tilt angle, it is possible to more reliably prevent the illumination light reflected by the inclined surface from being captured by the projection lens.

### 2. Second Embodiment (Spatial Light Modulation Module)

(1) Description of Second Embodiment

The present technology also provides a spatial light modulation module including: a panel unit that forms image display light; and a light shielding plate that defines an illumination light reachable range of the panel unit, in which a retardation plate is stacked on the light shielding plate. By stacking the retardation plate on the light shielding plate, the phase difference of the light reflected by the light shielding plate can be adjusted, and for example, the influence of the reflected light on the image can be reduced. For example, by imparting a phase difference equal to the phase difference imparted to the image display light by the pre-tilt of the panel unit to the light reflected by the light shielding plate, the optical path length of the image display light formed by the panel unit and the optical path length of the illumination light reflected by the light shielding plate become the same, and it is possible to make the contrast of these two lights the same. Therefore, it is possible to reduce the influence of the light reflected by the light shielding plate on the image.

In this embodiment, in the light shielding plate, the illumination light reachable surface of the light shielding plate does not have to be inclined with respect to the reflection surface of the panel unit (for example, the illumination light reachable surface may be parallel to the reflection surface), or, as described in “1. First embodiment (spatial light modulation module)” described above, the illumination light reachable surface may be inclined with respect to the reflection surface.

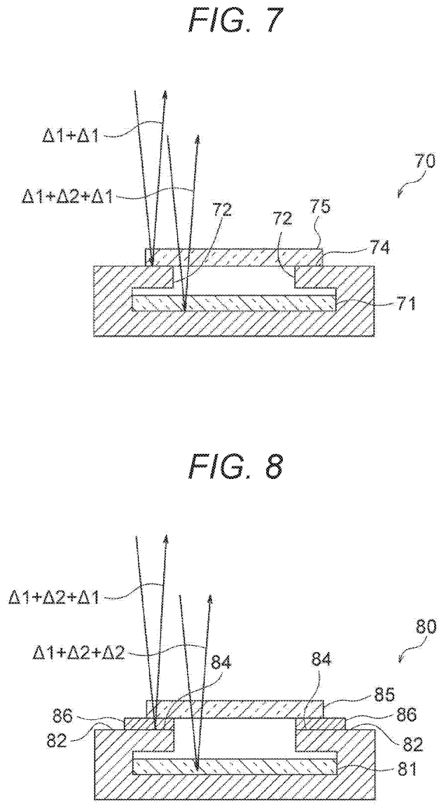

The basic concept of the spatial light modulation module of this example will be described below with reference to FIGS. 7 and 8. FIG. 7 is a simple schematic view of an example of a spatial light modulation module including a light shielding plate whose illumination light reachable surface is parallel to a panel surface and can reflect illumination light. FIG. 8 is a simple schematic diagram of an example of the spatial light modulation module according to the present technology.

In the spatial light modulation module 70 illustrated in FIG. 7, the illumination light reachable surface 74 of the light shielding plate 72 can reflect the illumination light. The illumination light that reaches the spatial light modulation module passes through the retarder 75 and reaches the light shielding plate 72. The passage of the retarder 75 imparts a phase difference Δ1 to the illumination light. Next, the illumination light is reflected by the light shielding plate 72 and passes through the retarder 75 again. The second passage of the retarder 75 imparts an additional phase difference Δ1 to the reflected light. That is, the phase difference of the light reflected by the light shielding plate 72 is Δ1+Δ1.

On the other hand, since the image display light formed by the panel unit 71 passes through the retarder 75 twice like the light reflected by the light shielding plate 72, a phase difference of Δ1+Δ1 is imparted to the image display light formed in the panel unit 71. Moreover, a phase difference Δ2 is imparted to the image display light by the pre-tilt of the liquid crystal in the panel unit 71. As described above, the phase difference of the image display light formed in the panel unit 71 is Δ1+Δ2+Δ1.

Due to the difference between the phase difference of the reflected light reflected by the light shielding plate 72 and the phase difference of the image display light, for example, as illustrated in FIG. 12(a), black level degradation occurs around the effective screen range.

The spatial light modulation module 80 illustrated in FIG. 8 includes: a panel unit 81 that forms image display light; and a light shielding plate 82 that defines an illumination light reachable range of the panel unit, in which a retardation plate 86 is stacked on the light shielding plate 82. The retardation plate 86 is stacked on the illumination light reachable surface 84 of the light shielding plate 82. The spatial light modulation module 80 further includes a retarder 85. Since the retardation plate 86 is stacked on the light shielding plate 82, the phase difference of the light reflected by the light shielding plate 82 can be adjusted. For example, when the retardation plate 86 imparts the phase difference that is the same as the phase difference imparted to the image display light by the pre-tilt of the liquid crystal in the panel unit 81, it is possible to make the phase difference Δ2 of the reflected light and the phase difference Δ2 of the image display light the same. Therefore, for example, as illustrated in FIG. 12(b), it is possible to prevent black level degradation from occurring around the effective screen range.

(2) Example of Second Embodiment (Example of Spatial Light Modulation Module)

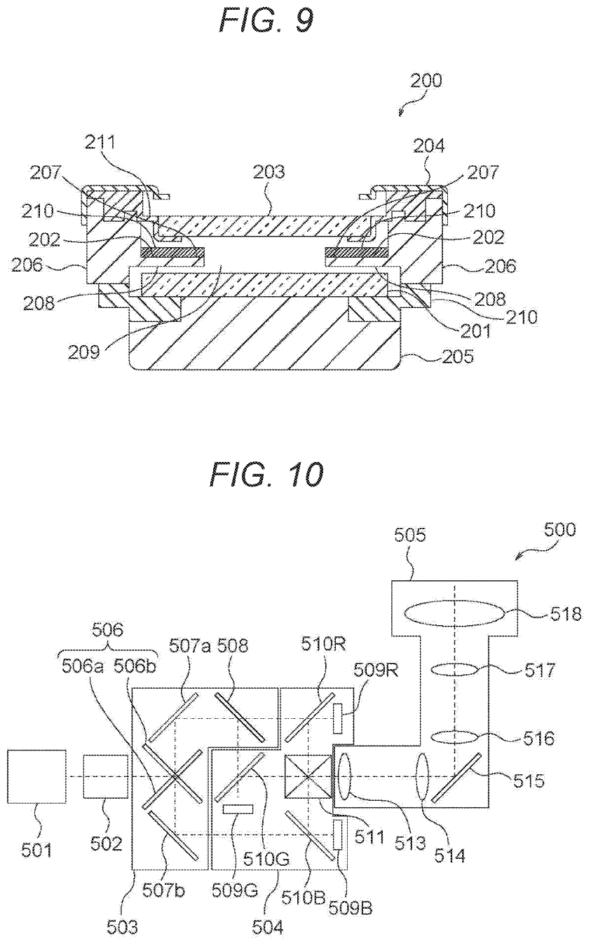

An example of the spatial light modulation module according to the present technology will be described below with reference to FIG. 9. FIG. 9 is a schematic cross-sectional view of a spatial light modulation module according to the present technology.

The spatial light modulation module 200 illustrated in FIG. 9 includes a panel unit 201, a light shielding plate 202 (integrated with a panel cover 206), a retarder 203, and a pre-light shielding plate 204. The spatial light modulation module 200 further includes a heat sink 205.

The panel unit 201, the retarder 203, the pre-light shielding plate 204, and the heat sink 205 are the same as the panel unit 101, the retarder 103, the pre-light shielding plate 104, and the heat sink 105 described above with reference to FIG. 3A, and description thereof also applies to this example.

The light shielding plate 202 defines the illumination light reachable range of the panel unit 201. The light shielding plate 202 has an illumination light reachable surface 207 and a panel side surface 208 on the opposite side of the illumination light reachable surface 207.

The light shielding plate 202 is provided with a window 209 for defining the illumination light reachable range. The illumination light that has passed through the window 209 reaches the panel unit 201, and the panel unit 201 modulates and reflects the illumination light to form image display light. The shape of the window 209 may be appropriately set according to the shape of the desired video region or the shape of the effective range of the panel unit 201, but is generally rectangular in a case of being viewed from the incident side of the illumination light (in a case where the panel unit 201 is viewed from the upper side of the drawing of FIG. 9).

The light shielding plate 202 has the illumination light reachable surface 207 and the surface 208 on the panel unit side. A retardation plate 210 is stacked directly above the illumination light reachable surface 207. It is preferable that the retardation plate 210 is configured so that the same phase difference as the pre-tilt of the liquid crystal of the panel unit 201 can be imparted to the light reflected by the light shielding plate 202.

The light shielding plate 202 may reflect the illumination light. The entire illumination light reachable surface 207 may reflect the illumination light. In order to reflect the illumination light, the illumination light reachable surface 207 may be mirror-finished, for example. By reflecting the illumination light, it is possible to prevent the temperature rise of the illumination light reachable surface 207 due to the illumination light, and this also suppresses the generation of radiant heat described above.

As illustrated in FIG. 9, the illumination light reachable surface 207 of the light shielding plate 202 does not have to be inclined with respect to the reflection surface of the panel unit 201, and may be parallel to the reflection surface, for example.

Alternatively, the illumination light reachable surface 207 of the light shielding plate 202 may be inclined with respect to the reflection surface of the panel unit 201 as described in “(2-1) Example of configuration of spatial light modulation module” in 1. above.

Also in the spatial light modulation module 200 of this example, the configuration of the modification described in (2-3) to (2-8) of 1. above may be adopted. The description in (2-3) to (2-8) of 1. above also applies to the spatial light modulation module 200 of this example.

### 3. Third Embodiment (Spatial Light Modulation Element)

The present technology also provides a spatial light modulation element used for configuring the spatial light modulation module described in “1. First embodiment (spatial light modulation module)” or “2. Second embodiment (spatial light modulation module)” above.

For example, the present technology provides a spatial light modulation element used in combination with a light shielding plate that defines an illumination light reachable range of a panel unit that forms image display light in the spatial light modulation element, at least a part of the illumination light reachable surface of the light shielding plate being inclined to a reflection surface of the panel unit. The panel unit and the light shielding plate that form the image display light are the panel unit and the light shielding plate described in 1. above, and the description thereof also applies to the present embodiment.

The combination of the panel unit and the light shielding plate is suitable for use in, for example, a projection type display device having high brightness. By adopting this combination, the effects described in 1. above are achieved.

Furthermore, the present technology also provides a spatial light modulation element used in combination with a light shielding plate that defines an illumination light reachable range of a panel unit that forms image display light in the spatial light modulation element, and having a retardation plate stacked on the light shielding plate. The panel unit and the light shielding plate that form the image display light are the panel unit and the light shielding plate described in 2. above, and the description thereof also applies to the present embodiment.

The combination of the panel unit and the light shielding plate is suitable for use in, for example, a projection type display device having high brightness. By adopting this combination, the effects described in 2. above are achieved.

### 4. Fourth Embodiment (Light Shielding Plate)

The present technology also provides a light shielding plate used for configuring the spatial light modulation module described in “1. First embodiment (spatial light modulation module)” or “2. Second embodiment (spatial light modulation module)” above.

For example, the present technology provides a light shielding plate used for defining an illumination light reachable range of a panel unit that forms image display light in the spatial light modulation element, at least a part of the illumination light reachable surface of the light shielding plate being inclined to a reflection surface of the panel unit. The panel unit and the light shielding plate that form the image display light are the panel unit and the light shielding plate described in 1. above, and the description thereof also applies to the present embodiment.

The combination of the panel unit and the light shielding plate is suitable for use in, for example, a projection type display device having high brightness. By adopting this combination, the effects described in 1. above are achieved.

Furthermore, the present technology also provides a light shielding plate used in combination with a light shielding plate that defines an illumination light reachable range of a panel unit that forms image display light in the spatial light modulation element, and having a retardation plate stacked on the light shielding plate. The panel unit and the light shielding plate that form the image display light are the panel unit and the light shielding plate described in 2. above, and the description thereof also applies to the present embodiment.

The combination of the panel unit and the light shielding plate is suitable for use in, for example, a projection type display device having high brightness. By adopting this combination, the effects described in 2. above are achieved.

### 5. Fifth Embodiment (Projection Type Display Device)

The present technology also provides a projection type display device including the spatial light modulation module described in “1. First embodiment (spatial light modulation module)” or “2. Second embodiment (spatial light modulation module)” above.

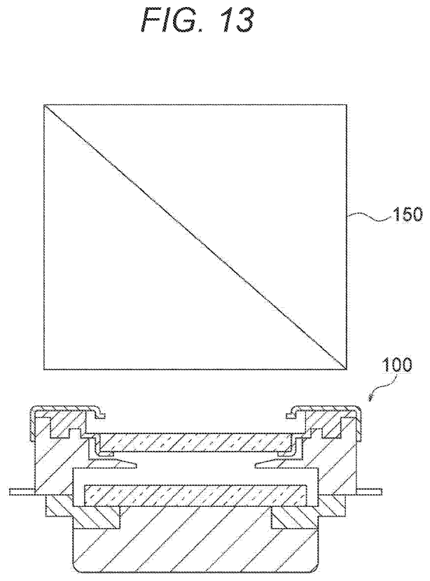

The projection type display device according to the present technology may include at least one combination of one PBS and one spatial light modulation module according to the present technology, for example, as illustrated in FIG. 13. For example, in a case where the projection type display device according to the present technology is a three-panel type, the projection type display device may include three combinations.

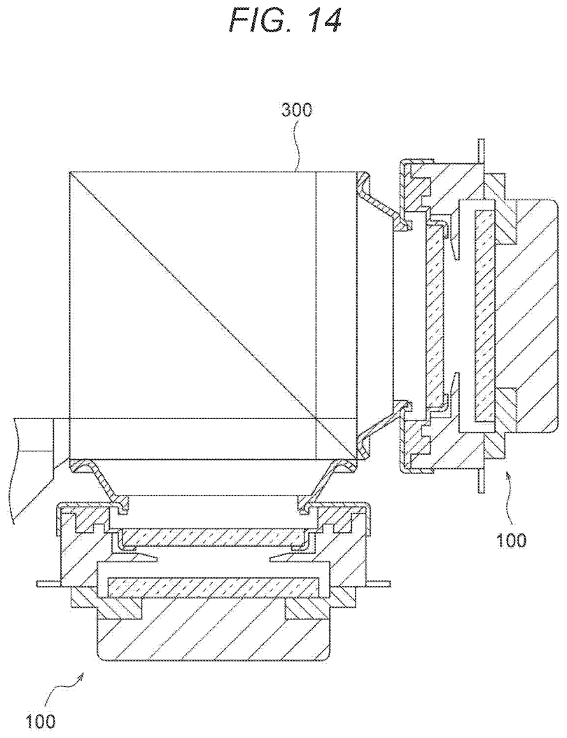

Furthermore, for example, the projection type display device according to the present technology may be configured such that one PBS prism 300 is shared by two spatial light modulation modules according to the present technology, as illustrated in FIG. 14. As described above, the present technology may be applied to a projection type display device in which two spatial light modulation modules share one PBS prism.

For example, the present technology provides a projection type display device including a spatial light modulation module including: a panel unit that forms image display light; and a light shielding plate that defines an illumination light reachable range of the panel unit, in which at least a part of an illumination light reachable surface of the light shielding plate is inclined with respect to a reflection surface of the panel unit. The panel unit and the light shielding plate that form the image display light are the panel unit and the light shielding plate described in 1. above, and the description thereof also applies to the present embodiment. By adopting the spatial light modulation module in a projection type display device, the effects described in 1. above are achieved.

Furthermore, the present technology provides a projection type display device including a spatial light modulation module including: a panel unit that forms image display light; and a light shielding plate that defines an illumination light reachable range of the panel unit, in which a retardation plate is stacked on the light shielding plate. The panel unit and the light shielding plate that form the image display light are the panel unit and the light shielding plate described in 2. above, and the description thereof also applies to the present embodiment. By adopting the spatial light modulation module in a projection type display device, the effects described in 2. above are achieved.

The projection type display device according to the present technology may include at least one spatial light modulation module according to the present technology, and may include, for example, one to three spatial light modulation modules according to the present technology.

For example, in a case where the projection type display device according to the present technology includes three spatial light modulation modules according to the present technology, the projection type display device may be configured as a so-called three-plate type projection type display device. An example of this projection type display device will be described below (1).

Furthermore, in a case where the projection type display device according to the present technology includes one spatial light modulation module according to the present technology, the projection type display device may be configured as a so-called single-plate type projection type display device, or may be configured as a projection type display device including a DMD array. An example of this projection type display device will be described below (2).

(1) First Example of Fifth Embodiment (Projection Type Display Device Including Reflective Liquid Crystal Display Element)

A configuration example of the projection type display device according to the present technology will be described below with reference to FIG. 10. A projection type display device 500 illustrated in FIG. 10 is a so-called three-panel type projection type display device including three reflective liquid crystal display elements. The projection type display device 500 modulates light for each of red light, green light, and blue light (each color light of RGB) by the three reflective liquid crystal display elements, and synthesizes the modulated light (image) for each color to project and display a color image. The projection type display device 500 includes a light source 501, an integrator optical system 502, a spectroscopic optical system 503, an image display light forming unit 504, and a projection lens system 505. For example, the elements included in the spectroscopic optical system 504 and the image display light forming unit 504 may be fixed at a predetermined position by a holding member (not shown) included in the projection type display device 500. Each of these components will be described below.

The light source 501 may be, for example, a lamp such as a xenon lamp, a metal halide lamp, a halogen lamp, or an ultrahigh pressure mercury lamp. Alternatively, the light source 501 may be a laser light source or an LED light source capable of emitting laser light. The light source 501 may further include a UV/IR cut filter, and the illumination light emitted from the light source 501 may pass through, for example, the UV/IR cut filter and reach the integrator optical system 502.

The integrator optical system 502 may make the illuminance of the illumination light emitted from the light source 501 uniform. The integrator optical system 502 may be, for example, a fly-eye integrator or a rod integrator. The fly-eye integrator may have, for example, two fly-eye lenses (a first fly-eye lens and a second fly-eye lens) and a condenser lens. The fly-eye integrator may further include a polarization conversion element. As the polarization conversion element, for example, a PBS prism array may be adopted.

The spectroscopic optical system 503 divides the illumination light that has been made uniform by the integrator optical system 502 into the three color lights described above and causes the color lights to be incident on each of the three reflective liquid crystal display elements described above. The illumination light emitted from the integrator optical system 502 is divided into illumination light including red light and green light and illumination light including blue light by a dichroic mirror 506.

Illumination light including red light and green light is reflected by a reflection mirror 507a and reaches a dichroic mirror 508. The dichroic mirror 508 divides the illumination light into red light and green light. The red light is incident on a reflective liquid crystal display element 509R. The green light is incident on a reflective liquid crystal display element 509G. The blue light is reflected by the reflection mirror 507b and is incident on a reflective liquid crystal display element 509B.

Note that the spectroscopic optical system 503 may include, for example, optical components such as a condenser lens and a polarization adjusting element on an optical path of each color light.

The image display light forming unit 504 may include: the three reflective liquid crystal display elements 509R, 509G, and 509B; reflective polarizing elements 510R, 510G and 510B that cause the image display light formed by each reflective display element to travel to, for example, a dichroic prism 511; and the dichroic prism 511. As the reflective polarizing elements 510R, 510G, and 510B, a prism-type polarizing beam splitter, a wire grid splitter, or the like may be used.

At least one of the three reflective liquid crystal display elements 509R, 509G, and 509B may be a spatial light modulation module according to the present technology, and preferably all three may be spatial light modulation modules according to the present technology. That is, each of these reflective liquid crystal display elements may be, for example, the spatial light modulation module described in “1. First embodiment (spatial light modulation module)” or “2. Second embodiment (spatial light modulation module)” above. By including the spatial light modulation module according to the present technology, the projection type display device 500 can achieve high brightness and solve the problem caused by the illumination light reaching the light shielding plate.

The projection lens system 505 may project the image display light formed by the image display light forming unit 504 onto an arbitrary projection surface in a desired size or shape. The projection lens system 505 may include at least one lens. In FIG. 10, the projection lens system 505 includes five lenses 513, 514, 516, 517, and 518, and a reflection mirror 515. The angle θ formed by the reflection surface of the panel unit of the reflective liquid crystal display elements 509R, 509G, and 509B and the inclined surface of the light shielding plate may be set so that Equation (1) described above is satisfied with respect to F# of the lens 513 through which the image display light emitted from the image display light forming unit 504 first passes, of the five lenses.

(2) Second Example of Fifth Embodiment (Projection Type Display Device Including DMD Array)

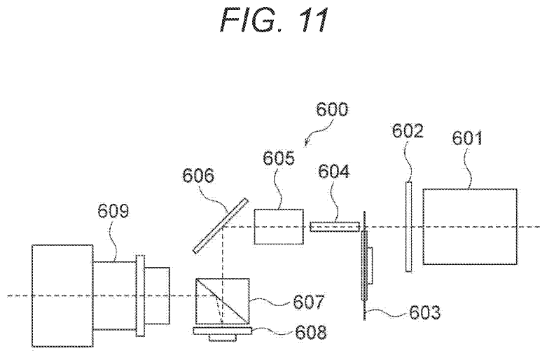

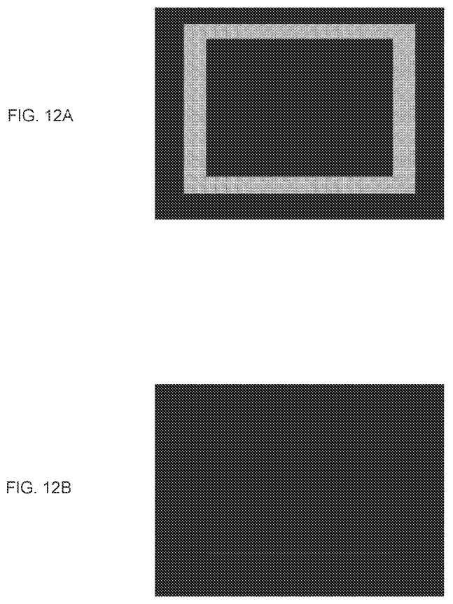

A configuration example of the projection type display device according to the present technology will be described below with reference to FIG. 11. The projection type display device 600 illustrated in FIG. 11 includes a spatial light modulation module including a DMD array. The projection type display device 600 is a projection type display device of a display field type that sequentially displays red, green, and blue fields using one DMD array and one rotating color filter disk (also called a color wheel). The projection type display device 600 includes a light source 601, a UV/IR filter 602, a color wheel 603, an integrator optical system (rod lens) 604, a relay lens group 605, a reflection mirror 606, a prism 607, a DMD array panel 608, and a projection lens system 609. Each of these components will be described below.

The contents described about the light source 501 in (1) described above applies to the light source 601. The UV/IR filter 602 cuts UV and/or IR from the illumination light generated by the light source 601.

The color wheel 603 color-separates the illumination light emitted from the light source 601 in a time-division manner and causes the separated light to be incident on the rod lens 604.

The rod lens 604 makes the illuminance of the illumination light uniform. Moreover, the rod lens 604 forms the shape of the illumination light into a rectangular shape. The illumination light emitted from the rod lens 604 is incident on the DMD array panel 608 via the relay lens group 605 and the reflection mirror 606.

The DMD array panel 608 modulates the illumination light to form an image display light. The DMD array panel 608 is a spatial light modulation module according to the present technology. That is, the DMD array panel 608 may be, for example, the spatial light modulation module described in “1. First embodiment (spatial light modulation module)” or “2. Second embodiment (spatial light modulation module)” above. By including the spatial light modulation module according to the present technology, the projection type display device 600 can achieve high brightness and solve the problem caused by the illumination light reaching the light shielding plate.

The image display light formed by the DMD array panel 608 is incident on the projection lens system 609 via the prism 607. The projection lens system 609 may project the image display light formed by the DMD array panel 608 onto an arbitrary projection surface in a desired size or shape. The projection lens system 609 may include at least one lens. For example, in a case where the projection lens system 609 includes a plurality of lenses, the angle θ formed by the reflection surface of the panel unit of the DMD array panel 608 and the inclined surface of the light shielding plate may be set so that Equation (1) described above is satisfied with respect to F# of the lens through which the image display light emitted from the DMD array panel 608 first passes, of the plurality of lenses.

### 6. EXAMPLE

### Test Example 1: Evaluation of Temperature Rise of Light Shielding Plate Included in Spatial Light Modulation Module

A mirror-finished light shielding plate (hereinafter, referred to as “light shielding plate 1”) and a matte black alumite-processed light shielding plate (hereinafter, referred to as “light-shielding plate 2”) were prepared. The temperature changes in a case where these two light shielding plates were continuously irradiated with light were compared. As a result, the temperature rise of the light shielding plate 1 was suppressed as compared with that of the light shielding plate 2. From this result, it can be seen that the temperature rise of the mirror-finished light shielding plate is suppressed as compared with the black alumite-processed light shielding plate.

### Test Example 2: Black Level Degradation Reduction Effect Due to Inclination of Light Shielding Plate Included in Spatial Light Modulation Module

In a spatial light modulation module (hereinafter, referred to as “module 1”) in which a light shielding plate having an illumination light reachable surface inclined with respect to the panel unit surface is provided on the panel unit, black level degradation around the screen when the screen is completely white was simulated by ray tracing calculation. In a spatial light modulation module (hereinafter, referred to as “module 2”) in which a light shielding plate having an illumination light reachable surface parallel to the panel unit surface is provided on the panel unit, black level degradation around the screen when the screen is completely white was also simulated by ray tracing calculation.

As a result of the simulation described above, in the module 1, black level degradation did not occur around the screen. On the other hand, in the module 2, black level degradation occurred around the screen.

On the basis of the simulation results described above, the following three spatial light modulation modules were created, and it was confirmed whether or not black level degradation around the screen occurred when the screen was completely white and when the screen was completely black.

(Module 3)

The illumination light reachable surface is subjected to matte black alumite processing and is not inclined (is parallel) to the plane of the panel unit.

(Module 4)

The illumination light reachable surface is mirror-finished and is inclined with respect to the plane of the panel unit as illustrated in FIG. 3A.

(Module 5)

The illumination light reachable surface is mirror-finished and is not inclined (is parallel) to the plane of the panel unit.

In the module 3, black level degradation did not occur around the screen when the screen was completely white and when the screen was completely black. Also in the module 4, black level degradation did not occur around the screen when the screen was completely white and when the screen was completely black. However, in the module 5, black level degradation occurred around the screen when the screen was completely white and when the screen was completely black. From these results, it can be seen that the module 4 which is mirror-finished and has an inclined surface can prevent the occurrence of black level degradation to the same extent as the module 3 including the conventional black-coated light shielding plate.

Furthermore, from the results of Test Examples 1 and 2, it can be seen that, by adopting a light shielding plate having an illumination light reachable surface that reflects light and is inclined with respect to the plane of the panel unit, in the spatial light modulation module, it is possible to prevent the temperature of the light shielding plate from rising due to the illumination light and reduce the black level degradation.

Note that, the present technology can also adopt the following configuration.

[1] A spatial light modulation module including:
a panel unit that forms image display light; and
a light shielding plate that defines an illumination light reachable range of the panel unit,
in which at least a part of an illumination light reachable surface of the light shielding plate is inclined with respect to a reflection surface of the panel unit.
   [2] The spatial light modulation module according to [1], in which the at least a part of the illumination light reachable surface reflects illumination light.
   [3] The spatial light modulation module according to [1] or [2], in which the panel unit is a reflective liquid crystal panel.
   [4] The spatial light modulation module according to any one of [1] to [3], in which illumination light reflected by the illumination light reachable surface is not captured by a projection lens through which the image display light passes.
   [5] The spatial light modulation module according to any one of [1] to [4],
in which an angle θ formed by the at least a part of the illumination light reachable surface and the reflection surface of the panel unit satisfies the following equation (1),

θ>sin⁻¹ (1/2F#) (1)

and
in Equation (1), F# is an F value on a panel unit side of a projection lens through which the image display light passes.
   [6] The spatial light modulation module according to any one of [1] to [5], in which, in the light shielding plate, an edge region that defines a window that defines the illumination light reachable range of the panel unit is inclined with respect to the reflection surface of the panel unit.
   [7] The spatial light modulation module according to [6], in which the edge region is inclined with respect to the reflection surface of the panel unit over an entire circumference of the window.
   [8] The spatial light modulation module according to any one of [1] to [7], in which a retardation plate is stacked on the light shielding plate.
   [9] The spatial light modulation module according to [8], in which a phase of illumination light is adjusted so that the retardation plate imparts, to the illumination light reflected by the light shielding plate, a phase difference equal to a phase difference imparted to an image display light by a pre-tilt of the panel unit.
   [10] The spatial light modulation module according to any one of [1] to [9], in which the light shielding plate is connected to a heat receiving medium that receives heat of the light shielding plate.
   [11] The spatial light modulation module according to [10], in which the light shielding plate and/or the heat receiving medium is formed including a metal material.
   [12] The spatial light modulation module according to any one of [1] to [11], in which the light shielding plate is a photoelectric conversion element.
   [13] The spatial light modulation module according to any one of [1] to [12], further including a damper that prevents illumination light reflected by the light shielding plate from reaching a projection lens or a projection lens housing.
   [14] The spatial light modulation module according to any one of [1] to [13], in which an end portion of an edge region that defines a window that defines the illumination light reachable range of the panel unit does not reflect illumination light.
   [15] The spatial light modulation module according to any one of [1] to [14], in which a surface of the light shielding plate opposite to the illumination light reachable surface absorbs light.
   [16] The spatial light modulation module according to [1] or [2], in which the panel unit includes a DMD array.
   [17] A spatial light modulation module including:
a panel unit that forms image display light; and
a light shielding plate that defines an illumination light reachable range of the panel unit,
in which a retardation plate is stacked on the light shielding plate.
   [18] A spatial light modulation element used in combination with a light shielding plate that defines an illumination light reachable range of a panel unit that forms image display light in the spatial light modulation element, at least a part of an illumination light reachable surface of the light shielding plate being inclined to a reflection surface of the panel unit.
   [19] A light shielding plate used for defining an illumination light reachable range of a panel unit that forms image display light in a spatial light modulation element, at least a part of an illumination light reachable surface being inclined to a reflection surface of the panel unit.
   [20] A projection type display device including a spatial light modulation module including: a panel unit that forms image display light; and a light shielding plate that defines an illumination light reachable range of the panel unit, in which at least a part of an illumination light reachable surface of the light shielding plate is inclined with respect to a reflection surface of the panel unit.

### REFERENCE SIGNS LIST

100 Spatial light modulation module

101 Panel unit

102 Light shielding plate

103 Retarder

1. A spatial light modulation module comprising:
a panel unit that forms image display light; and
a light shielding plate that defines an illumination light reachable range of the panel unit,
wherein at least a part of an illumination light reachable surface of the light shielding plate is inclined with respect to a reflection surface of the panel unit.

2. The spatial light modulation module according to claim 1, wherein the at least a part of the illumination light reachable surface reflects illumination light.

3. The spatial light modulation module according to claim 1, wherein the panel unit is a reflective liquid crystal panel.

4. The spatial light modulation module according to claim 1, wherein illumination light reflected by the illumination light reachable surface is not captured by a projection lens through which the image display light passes.

5. The spatial light modulation module according to claim 1,
wherein an angle θ formed by the at least a part of the illumination light reachable surface and the reflection surface of the panel unit satisfies Equation (1) below,
θ>sin⁻¹ (1/2F#) (1)
and
in Equation (1), F# is an F value on a panel unit side of a projection lens through which the image display light passes.

6. The spatial light modulation module according to claim 1, wherein, in the light shielding plate, an edge region that defines a window that defines the illumination light reachable range of the panel unit is inclined with respect to the reflection surface of the panel unit.

7. The spatial light modulation module according to claim 6, wherein the edge region is inclined with respect to the reflection surface of the panel unit over an entire circumference of the window.

8. The spatial light modulation module according to claim 1, wherein a retardation plate is stacked on the light shielding plate.

9. The spatial light modulation module according to claim 8, wherein a phase of illumination light is adjusted so that the retardation plate imparts, to the illumination light reflected by the light shielding plate, a phase difference equal to a phase difference imparted to an image display light by a pre-tilt of the panel unit.

10. The spatial light modulation module according to claim 1, wherein the light shielding plate is connected to a heat receiving medium that receives heat of the light shielding plate.

11. The spatial light modulation module according to claim 10, wherein the light shielding plate and/or the heat receiving medium is formed including a metal material.

12. The spatial light modulation module according to claim 1, wherein the light shielding plate is a photoelectric conversion element.

13. The spatial light modulation module according to claim 1, further comprising a damper that prevents illumination light reflected by the light shielding plate from reaching a projection lens or a projection lens housing.

14. The spatial light modulation module according to claim 1, wherein an end portion of an edge region that defines a window that defines the illumination light reachable range of the panel unit does not reflect illumination light.

15. The spatial light modulation module according to claim 1, wherein a surface of the light shielding plate opposite to the illumination light reachable surface absorbs light.

16. The spatial light modulation module according to claim 1, wherein the panel unit includes a DMD array.

17. A spatial light modulation module comprising:
a panel unit that forms image display light; and
a light shielding plate that defines an illumination light reachable range of the panel unit,
wherein a retardation plate is stacked on the light shielding plate.

18. A spatial light modulation element used in combination with a light shielding plate that defines an illumination light reachable range of a panel unit that forms image display light in the spatial light modulation element, at least a part of an illumination light reachable surface of the light shielding plate being inclined to a reflection surface of the panel unit.

19. A light shielding plate used for defining an illumination light reachable range of a panel unit that forms image display light in a spatial light modulation element, at least a part of an illumination light reachable surface being inclined to a reflection surface of the panel unit.

20. A projection type display device comprising a spatial light modulation module including: a panel unit that forms image display light; and a light shielding plate that defines an illumination light reachable range of the panel unit, wherein at least a part of an illumination light reachable surface of the light shielding plate is inclined with respect to a reflection surface of the panel unit.
